(19) United States
(12) Patent Application Publication
(10) Pub. No.: US 2008/0059551 A1
(43) Pub. Date: Mar. 6, 2008

(54) Device and Method for Composing Codes

(75) Inventors: Cornelis Hermanus Van Berkel, Eindhoven (NL); Patrick Peter Elizabeth Meuwissen, Eindhoven (NL); Ricky Johannes Maria Nas, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V.

(21) Appl. No.: 10/565,926

(22) PCT Filed: Jul. 13, 2004
(86) PCT No.: PCT/IB04/51201

§ 371 Date: Jan. 20, 2006

(30) Foreign Application Priority Data
Jul. 23, 2003 (EP) 03102265.0

(51) Int. Cl. G06F 7/38

(52) U.S. Cl. 708/490

(57) ABSTRACT

Configurable vector processors can be equipped with code generators, so that they are capable of handling different standards and codes. Furthermore, they can be arranged to provide support for related functions such as cyclic redundancy check (CRC). A configurable vector processor would then be equipped with a plurality of generators which generate basic codes in vector format. However, a disadvantage of such a configurable vector processor is that it cannot provide a composite code which is dependent on such basic codes. This is necessary if the configurable vector processors should be flexible enough to support a variety of CDMA-like standards. The device according to the invention is provided with at least two weighted sum units, which are able to make a selection out of a plurality of incoming basic-code vectors by means of a weighted sum operation, under the control of a configuration word. The elements of this configuration word represent the weighting factors which are used to select or deselect a basic-code vector. The selected basic-code vectors are added together and the result of the weighted sum operation is then output as an intermediate-code vector. Subsequently, the intermediate-code vectors are added together by an add unit and output as a composite-code vector. The ability to make selections out of a plurality of incoming basic-code vectors and to add intermediate-code vectors into a composite-code vector, together with the ability to configure the operations of the functional units of the device by means of configuration words, increases the flexibility of the device significantly. This flexibility is needed to support a variety of transmission standards.

The invention relates to a device arranged to compose basic-code vectors into a composite-code vector. The invention also relates to a method for composing basic-code vectors into a composite-code vector.

There is a variety of CDMA-like transmission standards, for example UMTS, CDMA2000, TD-SCDMA, and standards for other applications based on spread spectrum technology such as the global positioning system (GPS). Each of these standards uses a variety of different codes for synchronization, spreading and de-spreading, scrambling and de-scrambling, preambles and for other purposes. These codes are typically composed from a variety of basic codes, such as pseudo noise (PN) codes, Hadamard codes and OVSF codes. The basic codes often have parameters, for example generator polynomials, offsets and masks.

A specific composite code can typically be generated by relatively simple and cheap hardware, like a linear feedback shift register (LFSR). A UMTS receiver, for example, then uses a variety of such generators to generate a specific composite code. However, this specific composite code is directly associated with the UMTS standard and therefore it is not generic.

Configurable vector processors can be equipped with code generators, so that they are capable of handling different standards and codes. Furthermore, they can be arranged to provide support for related functions such as cyclic redundancy check (CRC). A configurable vector processor would then be equipped with a plurality of generators which generate basic codes in vector format. However, a disadvantage of such a configurable vector processor is that it cannot provide a composite code which is dependent on such basic codes. This is necessary if the configurable vector processors should be flexible enough to support a variety of CDMA-like standards.

In other words, to be applicable for the above-mentioned standards a configurable vector processor requires a single generator which is capable of supporting a plurality of transmission standards and codes, including support for related functions. It also requires that the single generator must produce a code vector of N elements, N being for example 16.

A code is also referred to as a sequence of symbols. A symbol is also referred to as a code chip or an element. A symbol may be a bit or another numerical value, either a real value or a complex value. A code vector is defined as a part of a complete code; the code vector comprises more than one symbol and is generated with a throughput of one vector per clock cycle.

US 2001/0048380 discloses a configurable code generator system for spread spectrum applications. This system comprises a composite code generator unit, a global code generator, and an interface that is coupled to the composite code generator and the global code generator. The system is capable of generating one code chip per clock cycle. The output code of the system may be a composite code based on several basic codes. It is also capable of generating several composite codes in parallel. However, the system is not capable of generating composite-code vectors comprising more than one code chip per clock cycle.

It is an object of the invention to provide a configurable generator of the kind set forth which is capable of generating composite-code vectors for a variety of transmission standards. This object is achieved by providing a device arranged to compose basic-code vectors into a composite-code vector and a method for composing basic-code vectors into a composite-code vector.

The device according to the invention is provided with at least two weighted sum units, which are able to make a selection out of a plurality of incoming basic-code vectors by means of a weighted sum operation, under the control of a configuration word. The elements of this configuration word represent the weighting factors which are used to select or deselect a basic-code vector. The selected basic-code vectors are added together and the result of the weighted sum operation is then output as an intermediate-code vector. Subsequently, the intermediate-code vectors are added together by an add unit and output as a composite-code vector. The ability to make selections out of a plurality of incoming basic-code vectors and to add intermediate-code vectors into a composite-code vector, together with the ability to configure the operations of the functional units of the device by means of configuration words, increases the flexibility of the device significantly. This flexibility is needed to support a variety of transmission standards.

An embodiment of the device is defined in claim 2, wherein one or more pre-processing units are provided. A pre-processing unit can be coupled between each weighted sum unit and the add unit. The pre-processing units can perform additional operations on the intermediate-code vectors, such as doubling of the length or applying a mask.

A further embodiment of the device is defined in claim 3, wherein a post-processing unit is provided. The post-processing unit can be coupled to the add unit and perform additional operations on the composite-code vector, such as a conditional negation.

If the code vectors are sequences of bits, then the embodiment defined in claim 4 is suitable. In that case, the weighted sum units calculate a bit-wise addition of the incoming basic-code vectors.

The embodiments defined in claims 5 and 6 comprise pre-processing units which perform specific functions, namely doubling of the length of the intermediate-code vectors, and applying a mask on the intermediate-code vectors, respectively. A post-processing unit performing a specific function is comprised in the embodiment defined in claim 7, wherein a conditional negation of the composite-code vector is performed.

New contents of the configuration words can be provided at regular intervals during a configuration stage of the device. The embodiments defined in claims 8, 9 and 10 comprise devices which are arranged to be configured in such a manner.

These and other aspects of the invention are described in more detail with reference to the drawings, in which:

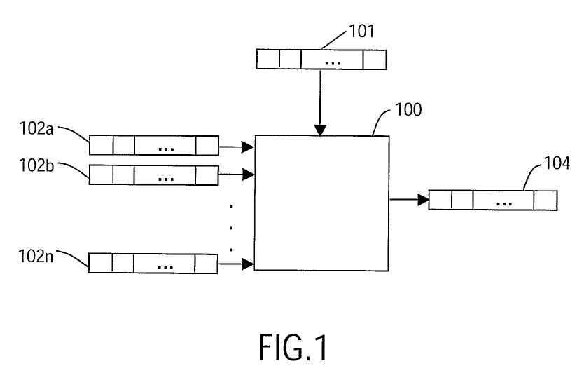

FIG. 1 illustrates a device arranged to combine basic-code vectors according to the invention;

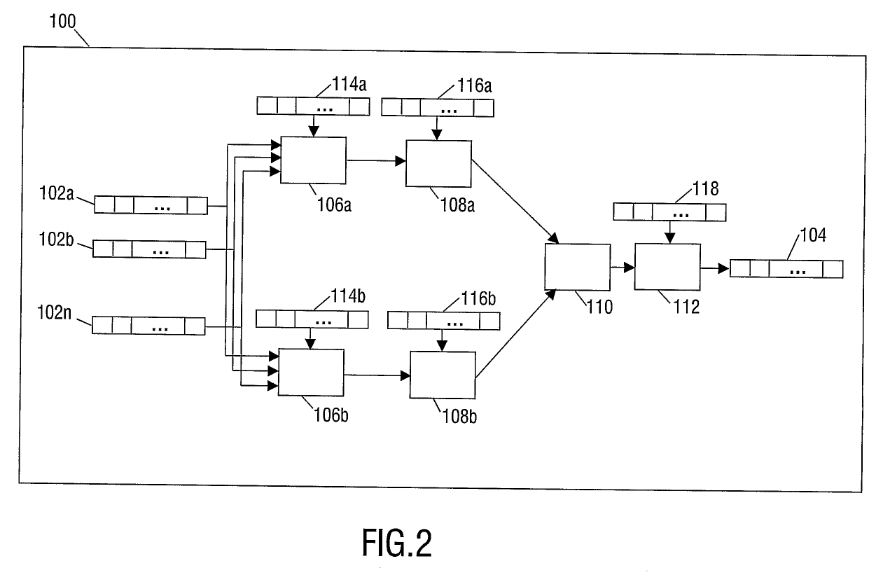

FIG. 2 illustrates various components of the device arranged to combine basic-code vectors according to the invention;

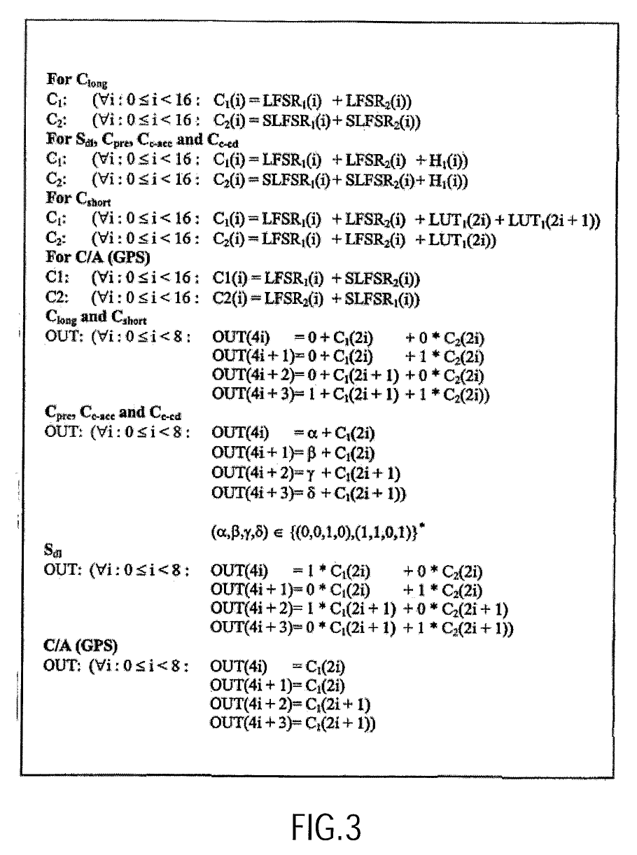

FIG. 3 illustrates an example of a functional specification of the device;

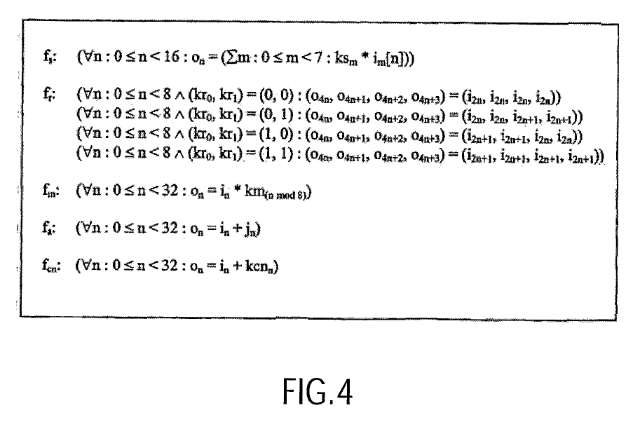

FIG. 4 illustrates an example of a functional specification of the components, corresponding with the example illustrated in FIG. 3.

FIG. 1 illustrates a device 100 arranged to combine basic-code vectors according to the invention. An input of the device 100 comprises a plurality of basic-code vectors 102a, 102b up to and including 102n. An output of the device 100 comprises a composite-code vector 104. The device 100 is capable of combining the basic-code vectors 102a, 102b up to and including 102n, under the control of a code configuration word 101. The use of the code configuration word 101 provides a certain degree of flexibility to the device 100, in the sense that the operation of the device 100 (determined by the functions which can be performed by the various components of the device 100) can be configured regularly.

FIG. 2 illustrates various components of the device 100 arranged to combine a plurality of basic-code vectors 102a, 102b up to and including 102n, according to the invention. The device 100 comprises at least two weighted sum units 106a, 106b, and an add unit 110. Optionally, the device 100 comprises one or more pre-processing units 108a, 108b. Furthermore, a post-processing unit 112 may be provided, which can be coupled to a weighted sum unit 106a, 106b, and to the add unit 110.

An input of the weighted sum units 106a, 106b receives a plurality of the basic-code vectors 102a, 102b up to and including 102n. The output of the weighted sum units 106a, 106b is provided as input to the add unit 110, or, if the device 100 comprises one or more pre-processing units 108a, 108b, as input to the pre-processing units. If the device 100 comprises one or more pre-processing units 108a, 108b, then the output of the pre-processing units is provided as input to the add unit 110. The output of the add unit 110 is the composite-code vector 104. Alternatively, if a post-processing unit 112 is deployed in the device 100, then the output of the add unit 110 is provided as input to the post-processing unit 112. In that case, the output of the post-processing unit 112 is the composite-code vector 104.

The code configuration word 101 can be split into smaller configuration words 114a, 114b, 116a, 116b, 118, which can be fed to several components of the device 100. A configuration word is also a sequence of symbols in vector format and the length of such a configuration word may vary; it is not per definition equal to the length of the basic-code vectors 102a, 102b up to and including 102n, the composite-code vector 104 or intermediate-code vectors produced by the components of the device 100. The configuration words 114a, 114b, 116a, 116b, 118, are used to configure the functions performed by the components 106a, 106b, 108a, 108b, 112, of the device 100.

FIG. 3 illustrates an example of a functional specification of the device 100. The specification applies to basic-code vectors with a length of 16 elements (bits) and a composite-code vector with a length of 32 elements (bits). The device 100 accepts as input a plurality of basic-code vectors 102a, 102b up to and including 102n, such as LFSR₁, LFSR₂, SLFSR₁, SLFSR₂, H₁, and LUT₁. In this example, LFSR₁ and LFSR₂ are basic-code vectors generated by linear feedback shift registers, SLFSR₁ and SLFSR₂ are the shifted or delayed output of the linear feedback shift registers, H₁ is a Hadamard basic-code vector and LUT₁ is a basic-code vector generated by means of a table look-up facility. It is specified which intermediate-code vectors C₁ and C₂ should be generated for several cases C_{long}, S_{dl}, Cₚᵣₑ, C_{c-acc}, C_{c-cd}, Cₛₕₒᵣₜ, and C/A (GPS), representing different codes for CDMA-like standards and for systems like GPS. It is also specified how a composite-code vector 104, referred to as OUT in the specification, should be generated on basis of the intermediate-code vectors C₁ and C₂, in each of the cases C_{long}, S_{dl}, Cₚᵣₑ, C_{c-acc}, C_{c-cd}, Cₛₕₒᵣₜ, and C/A (GPS).

The cases C_{long}, S_{dl}, Cₚᵣₑ, C_{c-acc}, C_{c-cd}, Cₛₕₒᵣₜ, and C/A (GPS), represent the following codes:
C_{long} represents a sum of two pseudo random noise (PRN) codes which are generated by linear feedback shift registers, and it also represents delayed versions of these codes;
S_{d1} represents a combination of a normal and a delayed version of a C_{long} code;
Cₚᵣₑ, C_{c-acc} and C_{c-cd} represent combinations of a C_{long} code and a Hadamard code;
Cₛₕₒᵣₜ represents a sum of three pseudo random noise (PRN) codes, two of which are generated by linear feedback shift registers and one by means of a look-up table facility;
C/A (GPS) represents a sum of two pseudo random noise (PRN) codes which are generated by linear feedback shift registers, and it also represents delayed versions of these codes, with configuration parameters different from C_{long}.

FIG. 4 illustrates an example of a functional specification of the components 106a, 106b, 108a, 108b, 110, 112, corresponding with the example as illustrated in FIG. 3.

Function fₛ is a function which can be performed by the weighted sum units 106a, 106b. In the specification, the elements of the intermediate-code vector are represented by oₙ, wherein variable ‘n’ identifies the location of the elements within the intermediate-code vector. The elements of the incoming basic-code vectors 102a, 102b up to and including 102n, are represented by iₘ[n], wherein variable ‘m’ identifies the basic-code vectors and variable ‘n’ identifies the location of the elements within a basic-code vector. In this case, the elements of the configuration words 114a, 114b are represented by ksₘ, wherein variable ‘m’ identifies the location of the elements. The number of elements of the configuration words 114a, 114b is 7, which is equal to the number of incoming basic-code vectors 102a, 102b up to and including 102n. According to the specification, the function selects a subset of the basic-code vectors 102a, 102b up to and including 102n, and calculates a bit-wise addition of them.

Function fᵣ is a function which can be performed by the pre-processing units 108a, 108b. In the specification, the elements of the intermediate-code vector are represented by i₂ₙ, i₂ₙ₊₁, and o₄ₙ, o₄ₙ₊₁, o₄ₙ₊₂, o₄ₙ₊₃, respectively, wherein variable ‘n’ is used to identify the location of the elements. The incoming intermediate-code vector is represented by i₂ₙ, i₂ₙ₊₁ and the outgoing intermediate-code vector is represented by o₄ₙ, o₄ₙ₊₁, o₄ₙ₊₂, o₄ₙ₊₃. The elements of the configuration words 116a, 116b are represented by kr₀, kr₁. According to the specification, the function doubles the length of the incoming intermediate-code vector by repeating and reordering elements. The pre-processing units 108a, 108b can erase, repeat and reorder the elements of the intermediate-code vectors.

Function fₘ is another function which can be performed by the pre-processing units 108a, 108b. The elements of the incoming and outgoing intermediate-code vector are represented by iₙ and oₙ, respectively, wherein variable ‘n’ identifies the location of the elements. The elements of the configuration words 116a, 116b are represented by km_{(n mod 8)}, wherein variable ‘n’ is used to identify the location of the elements. According to the specification, the function applies a mask on the intermediate-code vector.

Function fₐ is a function which can be performed by the add unit 110. According to the specification, two intermediate-code vectors iₙ and jₙ, wherein variable ‘n’ identifies the location of the elements within the intermediate-code vectors, are added using bit-wise addition and the result is output as the composite-code vector 104, represented by oₙ, wherein variable ‘n’ represents the location of the elements within the composite-code vector.

Function f_{cn} is a function which can be performed by the post-processing unit 112. The elements of the ingoing composite-code vector and outgoing composite-code vector are represented by iₙ and oₙ, respectively, wherein variable ‘n’ identifies the location of the elements. The elements of the configuration word 118 are represented by kcnₙ, wherein variable ‘n’ identifies the location of the elements. According to the specification, the function adds the contents of the configuration word to the composite-code vector 104 using bit-wise addition. This is also referred to as a conditional negation of the composite-code vector 104.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. A device (100) arranged to compose basic-code vectors (102a, 102b up to and including 102n) into a composite-code vector (104), the device (100) comprising:
at least two weighted sum units (106a, 106b), each weighted sum unit being arranged to provide an intermediate-code vector which is a weighted sum of a plurality of the basic-code vectors (102a, 102b up to and including 102n);
an add unit (110), the add unit being arranged to sum the intermediate-code vectors into the composite-code vector (104);
the weighted sum units (106a, 106b) being under the control of a first and a second configuration word (114a, 114b), wherein the first and the second configuration word (114a, 114b) are deployed to configure the operations performed by the weighted sum units.

2. A device (100) according to claim 1, wherein a pre-processing unit (108a, 108b) is coupled to at least one of the weighted sum units (106a, 106b) and to the add unit (110), the pre-processing unit (108a, 108b) being arranged to perform additional operations on the intermediate-code vector, the pre-processing unit (108a, 108b) being under the control of a third and a fourth configuration word (116a, 116b), wherein the third and the fourth configuration word (116a, 116b) are deployed to configure the additional operations on the intermediate-code vector.

3. A device (100) according to claim 1, wherein a post-processing unit (112) is coupled to the add unit (110), the post-processing unit (112) being arranged to perform additional operations on the composite-code vector (104), the post-processing unit (112) being under the control of a fifth configuration word (118), wherein the fifth configuration word (118) is deployed to configure the additional operations on the composite-code vector.

4. A device (100) according to claim 1, wherein the weighted sum units (106a, 106b) are arranged to calculate a bit-wise addition of at least two basic-code vectors (102a, 102b up to and including 102n).

5. A device (100) according to claim 2, wherein the pre-processing unit (108a, 108b) is arranged to erase, repeat and reorder the elements of the intermediate-code vector.

6. A device (100) according to claim 2, wherein the pre-processing unit (108a, 108b) is arranged to apply a mask on the intermediate-code vector.

7. A device (100) according to claim 3, wherein the post-processing unit (112) is arranged to perform a conditional negation of the composite-code vector (104).

8. A device (100) according to claim 1, wherein the weighted sum units (106a, 106b) and the add unit (110) are arranged to be configured during a configuration stage of the operation of the device (100).

9. A device (100) according to claim 2, wherein the pre-processing unit (108a, 108b) is arranged to be configured during a configuration stage of the operation of the device (100).

10. A device (100) according to claim 3, wherein the post-processing unit (112) is arranged to be configured during a configuration stage of the operation of the device (100).

11. A method for composing basic-code vectors (102a, 102b up to and including 102n) into a composite-code vector (104), the method comprising the steps of:
(a) providing a first and a second intermediate-code vector, each of which is a weighted sum of a plurality of the basic-code vectors (102a, 102b up to and including 102n);
(b) summing the intermediate-code vectors into a composite-code vector (104);
(c) providing a first and a second configuration word (114a, 114b);
(d) controlling step (a) with the first and the second configuration word (114a, 114b).
